(19) United States
(12) Patent Application Publication
(10) Pub. No.: US 2023/0368312 A1
(43) Pub. Date: Nov. 16, 2023

(54) METHOD FOR AUTOMATED WEED CONTROL OF AGRICULTURAL LAND AND ASSOCIATED STAND-ALONE SYSTEM

(71) Applicant: CYCLAIR, PRESSAC (FR)

(72) Inventor: Sébastien GORRY, PRESSAC (FR)

(21) Appl. No.: 18/029,876

(22) PCT Filed: Oct. 4, 2021
(86) PCT No.: PCT/FR2021/051715

§ 371 Date: Mar. 31, 2023

(30) Foreign Application Priority Data
Oct. 4, 2020 (FR) FR2010124
Oct. 28, 2020 (FR) FR2011039

(51) Int. Cl. G06Q 50/02; A01B 69/04; A01M 21/00; G06Q 10/0631

(52) U.S. Cl. CPC G06Q 50/02; A01B 69/008; A01M 21/00; G06Q 10/06313

(57) ABSTRACT

The invention relates to a method for maintaining agricultural land (110), comprising: preparing, by means of a computing device (160) comprising a processor (161) and a computer memory (162), a map of the agricultural land from previously acquired images of the agricultural land, a plurality of growing areas (120), each comprising a plurality of parallel growing rows (130), being defined in the map prepared; assigning a list of growing areas to be treated to a stand-alone vehicle (140) depending on an initial position and a final position of the stand-alone vehicle and the position of the growing areas to be treated; determining a travel plan for the stand-alone vehicle from the list of growing areas assigned to the vehicle with due regard to the orientation of the rows in the growing areas to be treated; and moving the stand-alone vehicle according to the previously established travel plan.

### TECHNICAL FIELD OF THE INVENTION

The invention relates to the field of agriculture.

More specifically, the invention relates to a method for automated weeding of an agricultural land and an associated stand-alone system.

In particular, the invention finds applications in the context of field crops, in particular for controlling secondary plants, called weeds or more commonly known as “weeds”, growing instead of the main plants cultivated on the agricultural land.

### PRIOR ART

Weed control is important to have a noticeable yield in a growing field because weeds can become the predominant plants in a field, de facto slowing down the growth of the cultivated plant in the field. It should be pointed out that this control is generally important in the first weeks of cultivation when the cultivated plant has not yet reached a sufficiently important growth stage to be the predominant plant.

Thus, techniques for maintaining an agricultural land by weeding are known from the prior art.

In general, these weeding techniques use herbicides such as glyphosate, spread over large areas to control weeds.

The major drawback of these techniques is that, although effective, the used products are generally harmful to the surrounding ecosystem.

Thus, the legislation becoming more and more restrictive on the use of such phytopharmaceutical products, restricting both the treatment periods and the range of active ingredients in order to reduce residues in plant production and diffuse pollution in the natural environment, other weeding techniques, such as mechanical ones, are increasingly preferred.

These techniques, which are generally tedious, require a regular monitoring of an agricultural land to perform weeding operations on time in order to avoid weeds becoming predominant on the cultivated field.

To overcome these drawbacks, techniques have been developed for automating these weeding tasks by automatically recognizing weeds on which a weeding action is performed.

Nonetheless, these techniques are generally based on a regular passage over an agricultural land, in order to be able to perform the weeding operation as soon as possible, which has the drawback of being time-consuming and very costly from an energy perspective.

For automation, techniques have also been developed using drones to perform a mapping of the land. Such examples are described in particular in the American patent application US2017/0127606 for guiding non-autonomous agricultural machines according to the relief of a land and in the Russian patent RU2710163 for identifying an abnormal growing area and guiding an agricultural machine there to treat this growing area. In particular, the Russian patent describes a delimitation of such a parcel in an image by defining a boundary thanks to a strong contrast, without specifically recognizing the origin of the culture anomaly noticed in the acquired images.

None of current systems allows addressing all of the required needs simultaneously, namely providing a stand-alone technique for weeding an agricultural land which is effective compared to the weeds growing on the agricultural land, without damaging the cultures in presence, and energy-efficient.

### DISCLOSURE OF THE INVENTION

### Objectives

The main objective of the invention is to provide a technique for weeding an agricultural land that is effective, allowing controlling weeds growing on the cultivated land on time.

Another important objective of the invention is to ensure the destruction of weeds without using phytopharmaceutical products that are harmful to the environment.

Another noticeable objective of the invention is to provide a technique that is stand-alone in particular in the planning, optimization and execution of the agricultural land treatment tasks.

Another objective of the invention is to provide a technique that is competitive with the phytopharmaceutical control means.

Another objective of the invention is to provide a technique that is optimized from an energy perspective, while being as ecological as possible.

Another objective of the invention is to provide a technique that is robust and suitable for field crops.

### Detailed Presentation

To this end, according to a first aspect, the invention relates to a method for maintaining an agricultural land, comprising steps of:
preparing, by a computing device comprising a processor and a computer memory, a map of the agricultural land from previously acquired images of the agricultural land and/or from geolocation data of an agricultural tool having previously covered the agricultural land, a plurality of growing areas each comprising a plurality of parallel growing rows being defined in the prepared map;
assigning by the computing device to a stand-alone vehicle a list of growing areas to be treated according to an initial position and a final position of the stand-alone vehicle and the position of the growing areas to be treated;
determining a travel plan for the stand-alone vehicle from the list of growing areas assigned to said vehicle, with due regard to the orientation of the rows of the growing areas to be treated;
moving the stand-alone vehicle according to the previously established travel plan.

Thus, the stand-alone vehicle moves within the agricultural land in an optimized manner while taking into account the relative position of the different growing areas as well as the orientation of the rows of each growing area to be treated.

It should be pointed out that each of the growing areas comprises parallel rows. Nonetheless, the rows of different growing areas are rarely parallel to each other. In general, the orientation of the growing rows corresponds to the movements of an agricultural machine that has sown the culture established in the growing area.

It should also be pointed out that the agricultural land may be vast, especially in the context of a field crop. By field crop, it should be understood a farm comprising a plurality of large agricultural parcels, generally discontinuous, with a great variability of soils, reliefs or obstacles, natural or not (stones, electric poles, ditches, hedges, river, etc.).

Advantageously, the maintenance method also comprises a step of generating by the computing device a diagnosis of the agronomic pressure inside all or part of the growing areas from previously acquired images of the agricultural land covering each growing area, the diagnosis of the agronomic pressure depending on the nature of the weed(s) present in the growing area, as well as their number and/or their development state, and wherein the list of growing areas to be treated by the stand-alone vehicle being ordered according to the agronomic pressure associated with each growing area.

Thus, the order of treatment of the growing areas is prioritized according to the agronomic pressure assessed for the growing areas. In other words, the growing areas to be treated as a priority are those with higher agronomic pressure than the others, thereby reflecting the presence of weeds in greater density and/or in a greater development state.

Thus, the assessment of the agronomic pressure allows having appropriate information to determine which growing areas are to be treated as a priority and consequently to optimize the actions of the stand-alone vehicle on the areas that urgently need intervention to avoid slowing the grown of the selected cultivated plant in the area.

Furthermore, the stand-alone vehicle generally moves slowly: around 1 km/h in the maintenance phase and around 5 km/h in the relocation phase. Consequently, the intervention of the stand-alone vehicle is optimally planned thanks to the assessment of the agronomic pressure. Thus, the areas where the agronomic pressure is the highest at a given time point can be treated as a priority by the stand-alone vehicle.

Of course, it should be pointed out that the relative position of the growing areas, with respect to the position of the stand-alone vehicle, and therebetween, is generally also taken into account in the scheduling of the list of growing areas to be treated in order to optimize the pathways of the stand-alone vehicle while prioritizing growing areas with high agronomic pressure from weeds.

In particular implementations of the invention, the step of generating a diagnosis of the agronomic pressure comprises a sub-step of automatic recognition of the nature of a weed present in an image thanks to an automatic learning method previously trained on a database of identified weed images.

In general, the recognized weed is a weed that is predominantly present in the image.

The automatic learning method, which is for example of the neural network type, allows recognizing the presence of a weed thanks to the parameters of the automatic learning method which have been generated during a training phase of the automatic learning method. In general, the training is performed in several steps in order to refine the parameters of the automatic learning phase to best recognize the presence of a weed in an image based on the database of previously identified weed images.

In general, the viewing angle is advantageously similar between the acquired images and the images in the database. For example, when the acquired images are captured from above, the training is performed on a database of images captured primarily in top view, i.e. according to a vertical viewing angle.

In particular implementations of the invention, the step of generating a diagnosis of the agronomic pressure comprises a sub-step of predicting an evolution of the developmental state of a weed at a given time point as a function of at least one measured and/or predicted meteorological data.

Thus, the assessment of the agronomic pressure is more accurate because it depends on at least one meteorological data such as hygrometry, instantaneous temperature, wind direction. It should be pointed out that the meteorological data can be measured at the time of calculation of the predicted evolution of the development state at a given time point, generally future. Thus, the prediction may be done for example over one day, over three days, over five days, over one week, over ten days, over fifteen days, over one month or over two months.

A meteorological parameter used for the prediction of the development state may also be predicted at the same given time point or at a distinct given time point.

In particular implementations of the invention, in the case where the maintenance method implements a plurality of stand-alone vehicles, the list of growing areas assigned to a stand-alone vehicle takes into account the order of the growing areas to be treated according to the agronomic pressure associated with each growing area and the position of each stand-alone vehicle at a given time point.

In particular implementations of the invention, the list of growing areas assigned to a stand-alone vehicle is prepared while taking into account the autonomy of said vehicle at a given time point with respect to a station for charging said vehicle.

Thus, the vehicle can return to the station, after having performed its maintenance operations on the growing areas assigned thereto, in order to charge an energy storage device, such as a battery or a hydrogen tank, included inside the stand-alone vehicle.

In particular implementations of the invention, the maintenance method also comprises a step of recognizing the direction of the rows of the growing area and determining a spacing between two rows from at least one acquired image covering said growing area and/or from a record of a plurality of positions of a seeding tool used during a preliminary seeding phase, the seeding tool comprising a geolocation device.

In general, this reconnaissance step is performed concomitantly with the step of preparing the map of the agricultural land, in particular in order to be able to define on the map the parallel growing rows within a growing area.

In particular implementations of the invention, the method comprises a step of automatically defining a growing area by analyzing the direction of the previously recognized rows.

In other words, the maintenance method also comprises a step of automatically defining a growing area on the agricultural land by means of automatic recognition of the direction of the rows of a growing area in at least one acquired image covering said growing area and/or based on a record of a plurality of positions of a seeding tool used during a prior seeding phase, the seeding tool comprising a geolocation device.

In particular implementations of the invention, the maintenance method also comprises a prior step of acquiring images of the agricultural land by at least one stand-alone image acquisition device.

Advantageously, the stand-alone image acquisition device is a stand-alone terrestrial robot or a stand-alone aerodyne. In general, the stand-alone image acquisition device comprises a motor-driven moving means such as a wheel or a propeller, as well as a camera.

In general, the images acquired by the stand-alone aerodyne are aerial images captured directly vertically above the agricultural terrain in order to limit perspective effects. Nonetheless, it could be provided for the aerodyne capturing images of the agricultural land from another angle of view.

For example, a stand-alone aerodyne may be a drone generally provided with at least one propeller able to confer a lift force on the drone, or a flying wing with no propeller.

In particular implementations of the invention, the overflight of an aerodyne is performed at a maximum altitude in the range of one hundred meters with respect to the surface of the agricultural land for mapping, and/or at a maximum altitude in the range of three meters for the establishment of the agronomic pressure of the weeds.

Advantageously, the flight for the establishment of the agronomic pressure in an area of the agricultural land is performed at a lower altitude than that performed for mapping in order to obtain a better resolution image of the ground, thereby allowing better detection of the nature of a weed present in the image. In general, this flight is referred to as very low altitude flight.

In implementations of the invention, the maintenance method comprises a step of determining at least one area where the movement of a stand-alone vehicle is prohibited on the map.

This prohibited area may correspond to the presence of an obstacle to the free movement of a stand-alone vehicle on the agricultural land. The obstacle may be of any type, such as the presence of a pole, a tree, a river, etc.

The establishment of a prohibited area may be performed automatically by the computing device or manually by an operator.

In implementations of the invention, the maintenance method also comprises a step of associating a culture type to at least one growing area of the agricultural land.

Thus, it is possible to refine the value of the agronomic pressure according to the evolution of the type of culture in the growing area.

Furthermore, since each culture has specific characteristics, it is possible to better assess the movements of a stand-alone vehicle by taking into account, for example, the typical row width adapted to the culture.

According to a second aspect, the invention also relates to a system for maintaining an agricultural land, comprising a computing device and at the at least one stand-alone vehicle equipped with a set of mechanical tools configured to perform agricultural land maintenance operations.

In such a system, the computing device comprises a computer memory storing instructions of a maintenance method according to any one of the preceding particular implementations.

In particular embodiments of the invention, the maintenance system also comprises at least one stand-alone image acquisition device.

For example, the stand-alone image acquisition device may be a terrestrial mobile robot, which may be referred to as “rover”, or an aerodyne.

In particular embodiments of the invention, the maintenance system also comprises a station for charging a stand-alone vehicle and/or a stand-alone image acquisition device.

### BRIEF DESCRIPTION OF THE DRAWINGS

Other advantages, aims and particular features of the present invention will appear from the following nonlimiting description of at least one particular embodiment of the devices and methods objects of the present invention, with reference to the appended drawings, wherein:

FIG. 1 is a schematic view of an example of a particular embodiment of a maintenance system according to the invention;

FIG. 2 is a synoptic view of an implementation of a maintenance method according to the invention implementing the maintenance system of FIG. 1;

FIG. 3 is an example of an image of the agricultural land subjected to maintenance during a step of the maintenance method of FIG. 2;

FIG. 3A is an example of a trace obtained by a seeding tool performing a seeding operation on a parcel of the agricultural land of FIG. 1;

FIG. 3B is an example of treatment of the trace of FIG. 3A performed during a step of the method of FIG. 2;

FIG. 4 is a synoptic view of a step of the maintenance method of FIG. 2;

FIG. 5 is a perspective view of the stand-alone vehicle of FIG. 1;

FIG. 6 is a perspective view of the drone of FIG. 1.

### DETAILED DESCRIPTION OF THE INVENTION

This description is given without limitation, each feature of an embodiment being able to be advantageously combined with any other feature of any other embodiment.

Note, as of now, that the figures are not to scale.

### Example of a Particular Embodiment

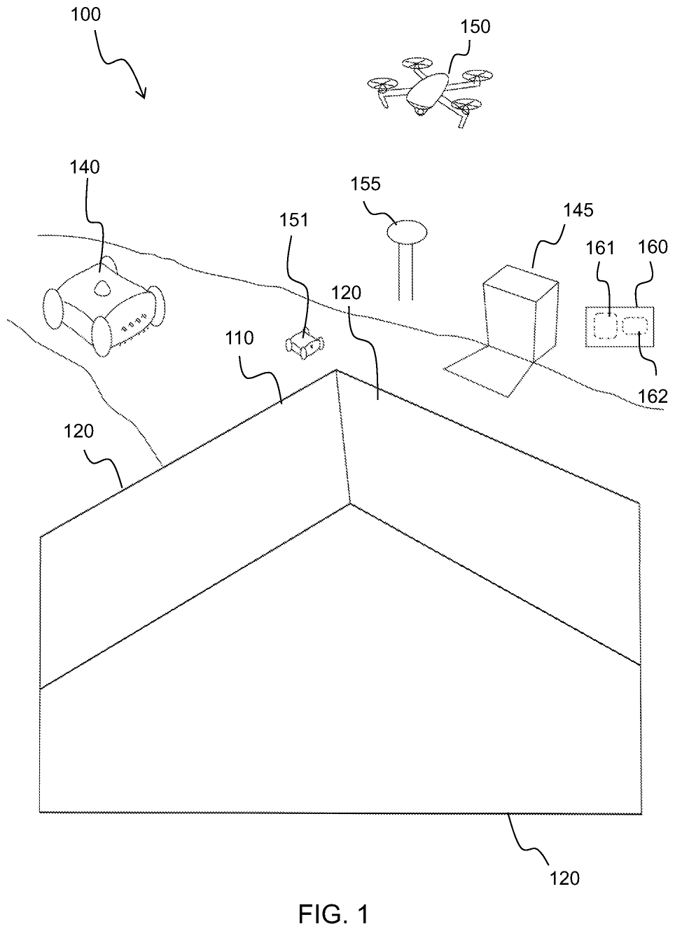

FIG. 1 illustrates a maintenance system 100 according to the invention used to perform weeding operations on an agricultural land 110 comprising a plurality of growing areas 120, each having a plurality of parallel growing rows 130.

In the present nonlimiting example of the invention, the agricultural land 110 comprises three contiguous growing areas 120, forming a parcel. Nonetheless, the invention can also be applied to a discontinuous agricultural land, having for example parcels remote from each other, each parcel comprising at least one growing area.

Furthermore, the plant, such as barley, wheat, maize or rapeseed, selected for cultivation in the three growing areas 120 is herein identical but could very well be distinct.

The maintenance system 100 herein comprises at least one stand-alone vehicle 140 configured to perform maintenance operations on the agricultural land 110, at least one drone 150, which is an aerodyne, configured to acquire at least one aerial-type image of the agricultural land 110 by flying over the agricultural land 110, at least one station 145 for charging the stand-alone vehicle, at least one station 155 for charging the drone 150 and a computing device 160, in this case a server, configured to manage the maintenance system 100.

It should be pointed out that the drone 150 is a stand-alone image acquisition device. Alternatively, or in addition to the drone 150, another motor-driven stand-alone image acquisition device, such as a second drone or a terrestrial mobile robot 151 acquiring partial images of the land during its movements, may be included in the maintenance system 100.

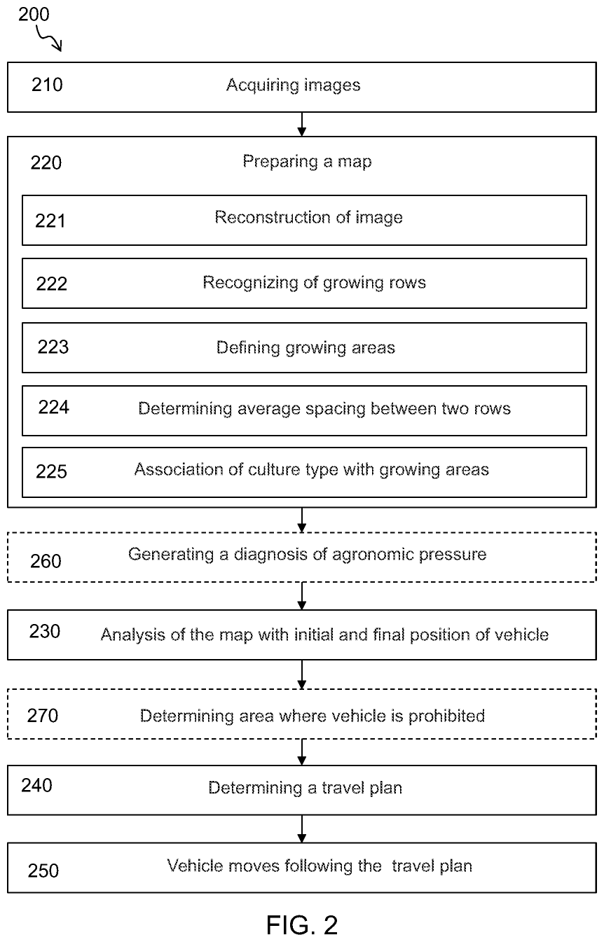

The computing device 160, comprising a processor 161 and a computer memory 162, processes instructions of a maintenance method 200 illustrated in FIG. 2 in the form of a synoptic diagram, stored in the computer memory 162.

The maintenance method 200 comprises a first step 210 of acquiring images by means of the drone 150 flying over the agricultural land 110 at a maximum altitude in the range of one hundred meters with respect to the surface of the agricultural land located vertically below the drone 150. Geographic coordinates, obtained for example by means of a geolocation device included in the drone 150, as well as an orientation of the image with respect to a cardinal point, are herein advantageously associated with each acquired image. The images acquired by the drone 150 are also generally time-stamped.

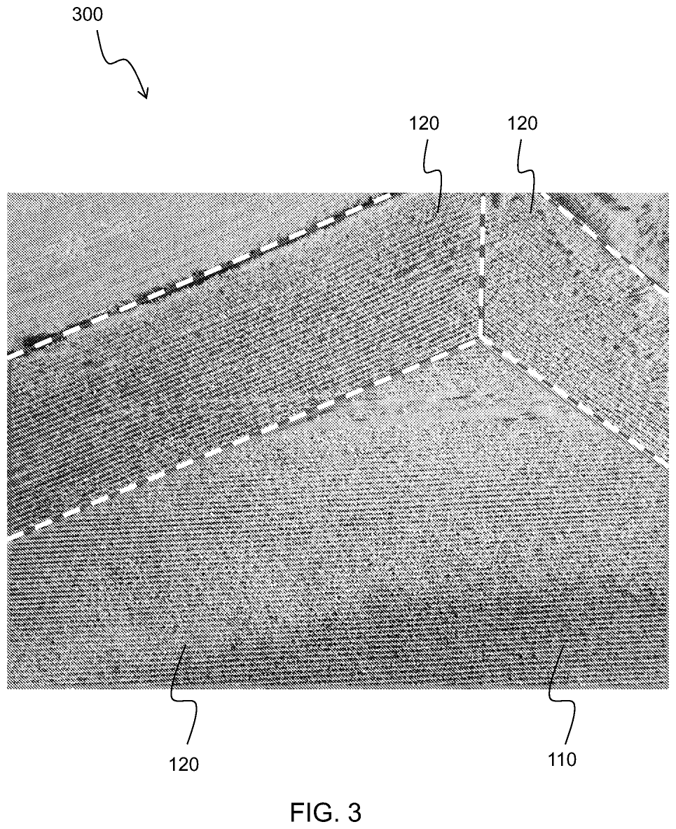

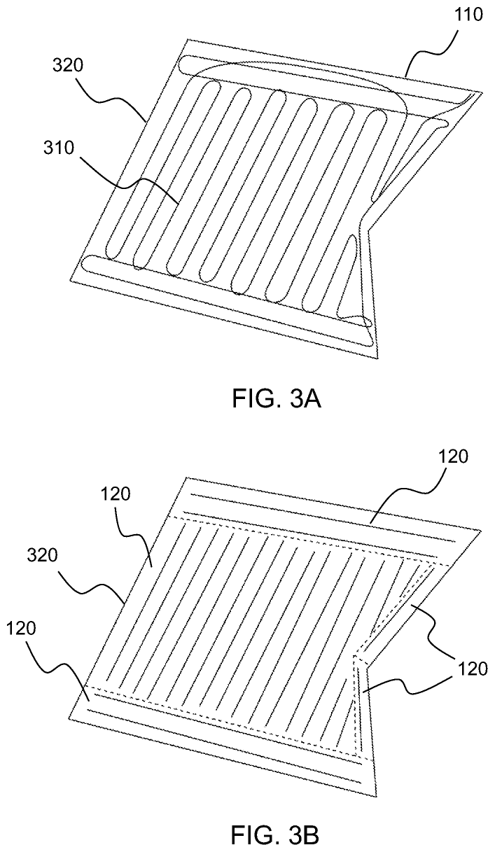

An example of an image 300 of the agricultural land 110 acquired by the drone 150 is shown in FIG. 3.

Based on the acquired images, the computing device 160 prepares, during a second step 220 of the method 200, a map of the agricultural land 110 in which the different growing areas 120 as well as the growing rows 130 are automatically defined.

To this end, an image of the agricultural land 110 is reconstituted beforehand based on a plurality of images acquired by means of the drone 150 during a first sub-step 221 of step 220. The reconstruction is performed while taking into account the geographical coordinates and the orientation associated with each image. The position of each image can be adjusted by superimposing at least two elements common to each image, for example by calculating a sharpness criterion at the superimposition of the images.

Afterwards, the growing rows 130 are recognized in the reconstituted image of the agricultural land 110 during a second sub-step 222 of step 220 by using, for example, an image segmentation or boundary detection method.

Alternatively or in complement, the recognition of growing rows is based on a record of the positions of a seeding tool used during a preliminary phase of seeding seeds on an agricultural land 110. To this end, the seeding tool comprises a geolocation device, for example of the GPS type (acronym of “Global Positioning System”), providing a position at regular intervals. The records over a period of time form a trail on a map. Thus, by analyzing this trace, it is possible to identify different growing rows 130 by identifying portions of the trace that are substantially straight over a predetermined length, for example equal to at least five or ten meters. An example of a trace 310 of the seeding tool covering a parcel 320 of the agricultural land 110 is illustrated in FIG. 3A. Advantageously, the trace is processed by removing the trace portions corresponding to intermediate pathways corresponding to movements of the seeding tool from one row to another row. The remaining trace portions correspond to the position of the growing rows 130, as illustrated in FIG. 3B.

When the position of the rows 130 is detected, their direction is analyzed in order to automatically define the growing areas 120, each defined by substantially parallel growing rows, in the reconstituted image of the agricultural land 110 during a third sub-step 223 of step 220. It should be pointed out that two growing rows are generally considered to be in the same growing area when they form an angle smaller than five degrees. For example, three growing areas 120 are determined on the image 300 of FIG. 3. As for FIG. 3B, the parcel 320 has been split into five growing areas 120.

It should be pointed out that an operator can possibly intervene during the method to make a correction or supplement to a boundary of a growing area 120 defined on the map.

Afterwards, an average spacing between two rows 130 may be determined for each growing area 120 during a fourth sub-step 224 of step 220. The average spacing is calculated based on lines each representing a row.

An association of a type of culture with at least one growing area 120 may also be performed during a possible fifth sub-step 225. This association may be automatically performed by recognition of the type of culture on an image or manually by an operator.

During a third step 230 of the method 200, an automatic analysis of the map on which an initial position and a final position of the stand-alone vehicle 140 are determined is performed by the computing device 160 to assign to the stand-alone vehicle 140 a list of growing areas to be treated, while taking into account its autonomy to move between the initial position and the final position. The initial position corresponds to a position at a given time point of the stand-alone vehicle 140, this position may be instantaneous or predicted. For example, the final position corresponds to the position of the charging station 145 of the stand-alone vehicle 140.

It should be pointed out that the stand-alone vehicle 140 generally moves slowly, at a speed in the range of 0.5 km/h to 2 km/h during maintenance of a growing area 120, and at a speed in the range of 4 to 6 km/h during a relocation travel, i.e. when not maintaining. This relocation may be one inside or outside a growing area 120.

A travel plan for the stand-alone vehicle 140 is then determined during a fourth step 240 of the method 200. This travel plan comprises an optimized trajectory for the stand-alone vehicle 140 allowing making the best use of the energy stored in an energy storage device comprised in the stand-alone vehicle 140, while complying with the movement constraints according to the growing rows of each growing area treated by the stand-alone vehicle 140.

During a fifth step 250 of the method 200, the stand-alone vehicle 140 moves by following the previously established travel plan.

In order to improve the assignment of the growing areas to be treated to the stand-alone vehicle 140, the method 200 may comprise, prior to step 230, a step 260 of generating by the computing device 160 a diagnosis of the agronomic pressure of the weeds inside all or part of the growing areas 120. The agronomic pressure due to a weed is assessed according to the nature of this weed, its density in a growing area and/or its development state. The agronomic pressure of a weed translates the capacity of the weed to become predominant in the analyzed growing area, thereby slowing down the growth of the cultivated plant in the area.

Thus, if the agronomic pressure of the weeds is low, the plant selected for cultivation can grow normally. Conversely, if the agronomic pressure of the weeds is high, for example higher than a predetermined threshold, the growth of the selected cultivated plant is much lower because the weeds become predominant in the growing area and derive elementary resources, such as water and the Sun, to their benefit, to the detriment of the growth of the selected cultivated plant.

For illustration, Table 1 presents the number of plants per m² sufficient to reduce the yield of straw cereals by 5%.

TABLE 1

| | |
|---|---|
| Galium | 1.8 |
| Common wild oat | 5.3 |
| Poppy | 22.0 |
| Matricaria | 22.0 |
| Ryegrass | 25.0 |
| Foxtail grass | 26.0 |
| Starwort | 26.0 |
| Veronica persica | 26.0 |
| Veronica filiformis | 44.0 |
| Lamium | 44.0 |
| Myosotis | 66.0 |
| Viola | 133.0 |
| Alchemilla | 133.0 |

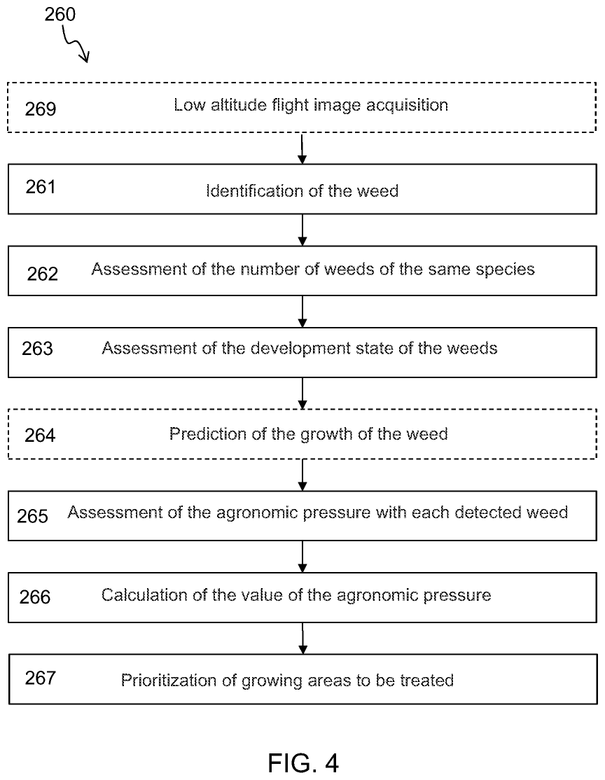

In order to assess the agronomic pressure related to a weed in a growing area, a recognition of the weed is generally performed during a first sub-step 261 of step 260 illustrated by a specific block diagram shown in FIG. 4, on at least one image of all or part of the corresponding growing area acquired beforehand.

For example, the recognition is performed by means of a neural network type automatic learning method, trained beforehand on a database of images of weeds whose identification has been performed beforehand. More specifically, the neural network allows indicating a probability of the presence of a weed in an image provided to the neural network.

It should be pointed out that the images used for recognition are generally distinct from those used for mapping. Indeed, in order to have a good recognition, it is preferable to use images having a very good resolution with a more restricted field of vision than that used for mapping. To this end, the drone 150 generally performs an overflight of the agricultural land, at a lower altitude, in the range of three meters, in order to acquire more accurate images of the ground during an optional preliminary sub-step 269. The drone 150 may also be equipped with several image acquisition devices with separate objectives, one dedicated to image acquisition for mapping with a wide field of view, i.e. with a short focal length, and the other one dedicated to the acquisition of images for the recognition of a weed with a narrower field of vision, i.e. with a larger focal length.

In the case of two stand-alone image acquisition devices, it may be considered to dedicate one to the acquisition of images for mapping and the other one to the acquisition of images for the recognition of a weed.

Afterwards, an assessment of the number of weeds of the same species in an image is performed during a second sub-step 262 of step 260. It should be pointed out that the assessment of the number of weeds on a surface is equivalent to the assessment of the density of weeds, for example per square meter.

For example, the assessment of the number of weeds may be performed automatically by counting the recognized weeds for a given species. This assessment may be performed on all images covering a growing area 120, or on a sample of images associated to a growing area 120.

The development state associated to a weed species detected in a growing area 120 is assessed during a third sub-step 263 of step 260 from the images acquired by estimating for example a characteristic value related to the growth of the weed, such as the size of the weed, the leaf number, the leaf density, the size of a leaf, etc. Afterwards, this characteristic value is compared to a scale characteristic of the growth of the weed to assess the associated development state.

In a variant of this particular implementation of the invention, the development state is obtained concomitantly with the identification of the weed by the automatic learning method. In such case, the database comprises weed images each associated with a development state of the weed.

A growth model adapted to the weed may be used to predict the evolution at a given time point of the development state of the weed, during an optional fourth sub-step 264 of step 260. For example, such growth models are described in the book “Plant Architecture and Growth, Modeling and Applications” by P. de Reffye et. al.

It should be pointed out that the used growth model can be supplemented with current and/or predicted meteorological data, such as temperature, wind direction, hygrometry, sunshine or rainfall, in order to improve the prediction of the evolution of the state of the weed. This prediction may be performed over one day, three days or five days, and possibly over 1 or 2 month(s).

Based on the current and/or future development state of the weed, an assessment of the agronomic pressure associated with each weed detected in a growing area is performed during the fifth sub-step 265 of step 260. For example, a weed with an advanced development state has a higher agronomic pressure than a weed with a lower development state.

It should be pointed out that the assessment of this agronomic pressure may also take into account a comparison of the growth of the weed with the growth of the cultivated plant at a given time point, either current or future.

For illustration, Table 2 presents an example of the evolution of the agronomic pressure of different types of weeds, taking into account a simplified model of plant growth according to the sunshine duration, the temperature and the hygrometry. The parameters used herein are 14 h of sunshine per day, a hygrometry of 70% and a temperature of 10° C.

TABLE 2

| | Evolution | Day | | | | |
|---|---|---|---|---|---|---|
| Area | index | D 0 | D 0 + 5 | D 0 + 10 | D 0 + 15 | D 0 + 20 |
| PAA 1 | 0.3 | 12 | 14 | 17 | 21 | 27 |
| PAA 2 | 0.2 | 25 | 26 | 28 | 32 | 37 |
| PAA 3 | 1.4 | 2 | 9 | 23 | 45 | 73 |
| PAA 4 | 1.1 | 57 | 62 | 73 | 89 | 110 |
| PAA 5 | 2.1 | 5 | 16 | 37 | 68 | 111 |

In table 2, it is possible to notice that the area PAA 5 could be treated as a priority instead of the area PAA 2 because, although it has a lower agronomic pressure at time 0, the weed will tend to grow very quickly as shown by the value of the agronomic pressure after 20 days, which is three times higher than the agronomic pressure of the area PAA 2. Thus, the order of the growing areas 120 to be treated may be modified while taking into account the agronomic pressures of the weeds expected at a given time period.

A representative value of the agronomic pressure of the weeds is calculated during a sixth step 266 of step 260 for each growing area 120 by combining the agronomic pressures of each weed detected on each growing area 120. For example, the representative value may correspond to a maximum value, to an average value of the agronomic pressures or to a sum of the values of the agronomic pressures associated to each weed detected in the growing area 120.

It should be pointed out that an agronomic pressure or a representative value of the agronomic pressure in a growing area may be weighted according to the type of the cultivated plant in the corresponding growing area, in order to take into account the relationship between the development of the cultivated plant and of the weeds. Furthermore, this weighting allows better comparing the agronomic pressures of the weeds between different growing areas in which different plants are cultivated.

Afterwards, a classification of the growing areas 120 to be treated as a priority is performed during a seventh sub-step 267 of step 260.

The list assigned to the stand-alone vehicle 140 during step 230 can then take into account the order of the growing areas 120 to be treated as a priority. Thus, a growing area 120 wherein the agronomic pressure of weeds is high can be treated as a priority by the stand-alone vehicle 140. It should be pointed out that this growing area 120 to be treated as a priority is not necessarily the growing area 120 the closest to the stand-alone vehicle 140 which will thus expend energy to move up to this growing area 120 to be treated as a priority.

In the case where the maintenance system 100 comprises a plurality of stand-alone vehicles 140, the distribution of the growing areas 120 to be treated between the different stand-alone vehicles is optimized by taking into account the order of the growing areas 120 to be treated as a priority and the position of each stand-alone vehicle 140 at a given time point. This optimization generally also takes into account the position of one or more charging station(s) 145 by managing the charging times of each stand-alone vehicle 140.

Indeed, it should be pointed out that the number of charging stations 145 may be smaller than the number of stand-alone vehicles 140. In such case, the charging of all stand-alone vehicles 140 being impossible to be performed simultaneously, a clever management of the charging periods of each stand-alone vehicle 140 may be put in place in order to avoid unnecessarily immobilizing a stand-alone vehicle 140.

In order to avoid a stand-alone vehicle 140 being disturbed by an obstacle during movement thereof or being able to move outside of a dedicated space, the method 200 may advantageously comprise, before the step 240 of determining a movement, a step 270 of determining at least one area where the movement of a stand-alone vehicle 140 is prohibited on the map. This prohibited area may be automatically identified beforehand on an image by recognizing, for example, an obstacle such as a pole, a tree, a river, a ditch, a significant relief, a roadside, etc. This prohibition area may also be added to the map by an operator.

Thus, the stand-alone vehicle 140 can maintain the agricultural land 110 with due regard to the order of areas 120 to be treated which are assigned thereto.

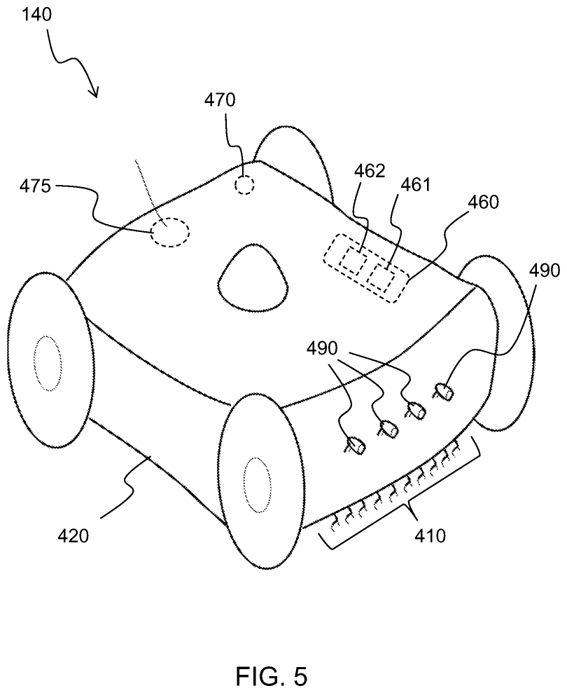

To this end, as illustrated in more detail in FIG. 5, the stand-alone vehicle 140 is equipped with a set of specific mechanical tools 410, generally weeding type ones, oriented towards the agricultural land 110. The tools 410 are herein located under the chassis 420 of the stand-alone vehicle 140.

The frame 420 accommodates an electronic device 460 equipped with a processor 461 and a computer memory 462 allowing in particular controlling the movement of the stand-alone vehicle 400 based on the previously established travel plan.

To follow the travel plan, the stand-alone vehicle 140 may advantageously comprise a geolocation device 470, for example of the satellite geo-positioning type such as the GPS system (acronym of “Global Positioning System”) or Galileo.

It should be pointed out that the travel plan has generally been communicated to the stand-alone vehicle 140 via a wireless communication device 475 included in the stand-alone vehicle 400, and connected to the electronic device 460.

To locally detect the presence of a weed, the stand-alone vehicle 140 is herein provided with four cameras 490, located at the front of the vehicle 140, and whose optical axis is advantageously oriented towards the ground on which the stand-alone vehicle moves 140. Thus, images acquired at regular intervals by the cameras are analyzed by the electronic device 460 which can control the action of a mechanical tool 410 depending on the weed recognized in the image. The recognition of a weed is herein performed by a neural network-type automatic learning method, previously trained on a database of images of identified weeds.

The images acquired by the cameras 490 may also be transmitted to the computing device 160 of the maintenance system 100 in order to improve mapping of the agricultural land and determination of a better agronomic pressure of the weeds. Thus, a correlation may be performed between the agronomic pressure of the weeds assessed on the growing area 120 being treated by the stand-alone vehicle 400 and the agronomic pressure of the weeds observed during the treatment. This correlation allows improving the assessment of the agronomic pressure of weeds based on the images acquired by means of the drone 150.

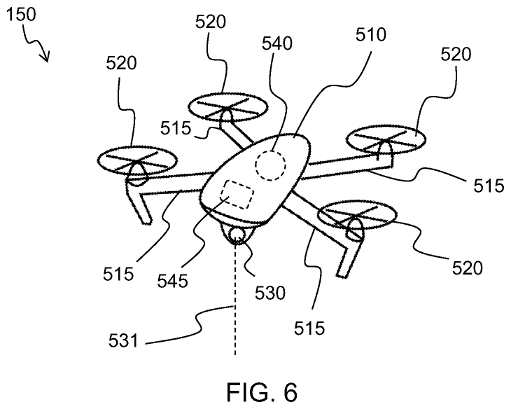

FIG. 6 is a perspective view of the drone 150 of the maintenance system 100 implemented by the maintenance method 200.

The drone 150 includes a frame 510 provided with four arms extending in a main plane of the frame 510. A motor-driven propeller 520 is disposed at each end of the arms 515, each rotating in a plane parallel to the main plane 511 of the frame 510. The four propellers 520, disposed opposite a so-called upper face of the drone 150, thereby generating during actuation thereof a lift force of the drone 150.

The drone 150 has on a face opposite to the upper face, an image acquisition device 530, in this instance a camera, whose optical axis 531 is herein perpendicular to the main plane 511 of the frame 510. The optical axis 531 is directed so as to enable the camera 530 to acquire aerial images of the land 110 captured substantially vertically.

The drone 150 also comprises a battery 540 for storing electrical energy as well as an inductive charging device 545.

It should be pointed out that the drone 150 can move automatically or be piloted by an operator.

1-15. (canceled)

16-30. (canceled)

31. A method for maintaining an agricultural land, comprising:
preparing, by a computing device comprising a processor and a computer memory, a map of the agricultural land, the map delimiting a plurality of growing areas each growing area of the plurality comprising a plurality of parallel growing rows;
assigning to a stand-alone vehicle a list of growing areas to be treated according to an initial position and a final position of the stand-alone vehicle and a position of the growing areas to be treated;
determining a travel plan for the stand-alone vehicle from the list of growing areas to be treated, with reference to an orientation of the parallel growing rows of the growing areas to be treated;
moving the stand-alone vehicle according to the travel plan; and
the method further comprising a step of generating, by the computing device, a diagnosis of an agronomic pressure inside of the plurality of growing areas of the agricultural land, the diagnosis of the agronomic pressure depending on a nature of a weed present in a growing area of the plurality of growing areas, as well as a number of weeds present and a development state of the weed present, the list of growing areas to be treated by the stand-alone vehicle being ordered according to the agronomic pressure associated with each growing area to be treated.

32. The method of claim 31 wherein preparing the map of the agricultural land further comprises using a geolocation data of an agricultural tool having previously covered the agricultural land.

33. The method of claim 31 wherein preparing the map of the agricultural land further comprises using previously acquired images of the agricultural land.

34. The method of claim 31, wherein the step of generating the diagnosis of the agronomic pressure comprises a sub-step of automatic recognition of the nature of the weed present by an image of the weed present and an automatic learning method trained on a database comprising identified weed images.

35. The method of claim 31, wherein the diagnosis of the agronomic pressure in the growing area is further based on a comparison between a growth of the weed present and the growth of a plant cultivated in the growing area.

36. The method of claim 31, wherein the step of generating the diagnosis of the agronomic pressure comprises a sub-step of predicting an evolution of a developmental state of the weed present at a given time point as a function of at least one among a measured meteorological data and a predicted meteorological data.

37. The method of claim 31, implementing a plurality of stand-alone vehicles, wherein the list of growing areas to be treated and assigned to the stand-alone vehicle takes into account an order of the growing areas to be treated according to the agronomic pressure associated with each growing area and a position of each stand-alone vehicle at a given time.

38. The method of claim 31, wherein the list of growing areas to be treated and assigned to the stand-alone vehicle is taking into account an autonomy of the stand-alone vehicle at a given time with respect to a charging station adapted to charging the stand-alone vehicle.

39. The method of claim 31, further comprising recognizing a direction of the parallel growing rows in the growing area and determining a spacing between two parallel growing rows from at least one acquired image covering the growing area.

40. The method of claim 39, wherein recognizing a direction of the parallel growing rows in the growing area and determining a spacing between two parallel growing rows comprises using a record of a plurality of positions of a seeding tool used during a preliminary seeding phase, the seeding tool comprising a geolocation device.

41. The method of claim 39, further comprising automatically defining the growing area by analyzing the direction of the parallel growing rows.

42. The method of claim 40, further comprising automatically defining the growing area by analyzing the direction of the parallel growing rows.

43. The method of claim 31, comprising a prior step of acquiring an image of the agricultural land by at least one stand-alone image acquisition device.

44. The method of claim 43, wherein the at least one stand-alone image acquisition device is an aerodyne adapted to flying over the agricultural land at a maximum altitude of 100 meters with respect to a surface of the agricultural land for preparing the map of the agricultural land and adapted to flying over the agricultural land at the maximum altitude of 3 meters relative to the surface of the agricultural land for making the diagnosis of the agronomic pressure.

45. The method of claim 31, further comprising determining at least one area on the map of the agricultural land where a movement of the stand-alone vehicle is prohibited.

46. The method of claim 31, further comprising associating a culture type to at least one growing area of the agricultural land.

47. A system for maintaining an agricultural land, comprising the computing device including the computer memory adapted for storing instructions for the implementation of the method of claim 31, and at least one stand-alone vehicle equipped with a mechanical tool configured to perform an agricultural land maintenance operation.

48. The system of claim 47, also comprising at least one stand-alone image acquisition device.

49. The system of claim 47, further comprising a charging station adapted for charging the stand-alone vehicle.

50. The system of claim 48, further comprising a charging station adapted for charging the at least one stand-alone image acquisition device.
